(19) United States
(12) Patent Application Publication
(10) Pub. No.: US 2007/0198418 A1
(43) Pub. Date: Aug. 23, 2007

(54) System and method for facilitating fund-raising through online digital media content sales

(75) Inventors: Frederic A. Macdonald, Santa Monica, CA (US); Joel Hladecek, West Hollywood, CA (US); Albert F. Young JR., Midlothian, VA (US)

Correspondence Address: MCGUIREWOODS, LLP, 1750 TYSONS BLVD, SUITE 1800, MCLEAN, VA, 22102, US

(73) Assignee: MODstream, LLC, Midlothian (US)

(21) Appl. No.: 10/591,169

(22) PCT Filed: Mar. 1, 2005
(86) PCT No.: PCT/US05/06234

§ 371 Date: Aug. 30, 2006

Related U.S. Application Data
(60) Provisional application No. 60/548,187, filed on Mar. 1, 2004.

(51) Int. Cl. H04L 9/00

(52) U.S. Cl. 705/52

(57) ABSTRACT

A system (100) and method for managing fond raising activities by various types of organizations (210) through the promotion and sale of digital media content (160) is provided. Vouchers or media cards (152), for redemption of songs, videos, animation, games, etc., may be provided to non-profit organizations (210) or other organizations for subsequent sale to consumers (215) to raise monies associate with an event or promotion. The vouchers (152) may have an identifier that permits a consumer to redeem the voucher (152) either on-line (e.g., a web site) (140) or through in-store locations (145). The vouchers (152) may be tracked and accounted for along the process and checks are made to determine validity of a (voucher152) presented for redemption. When a valid voucher (152) is redeemed, a download of the associated digital media (160) may occur to a consumer's device (135). Accounting of fees received and paid to media providers and the organizations may also be provided.

### FIELD OF THE INVENTION

The invention generally relates to a system and method for facilitating fund raising and more particularly to a system and method for facilitating fund raising using on-line sales of digital content.

### BACKGROUND

With federal, state and local funds being cut from youth and education programs across the country, organizations increasingly need to take a more active role in raising money and becoming self-sufficient. Non-profit organizations (NPOs) in particular need a new method for raising money that is timely, is easy and low-cost to implement, has broad appeal, provides incremental income to their organizations, and is totally in keeping with the NPO's high standards and focus on public service.

According to the International Federation of the Phonographic Industry, Global CD sales brought in approximately $28.9 billion in revenue in 2002, down 7% from 2001. Two pro-offered reasons for this significant decrease include an increase in online music sales and continued piracy. The following are several statistics and ancillary facts which indicate the rapid transition from retail to online music sales.
According to estimates from one prominent industry research firm, U.S. spending on online music will rise to $3.3 billion, or about 26 percent of all U.S. music spending, by 2008. This may be a conservative figure.
To serve the music downloading market, dozens of online stores are hoping to ride the wave. Some are independent, but many are sponsored by the biggest names in technology and, joining a field which already includes iTunes®, Napster®, Buymusic.com, Yahoo!Music® and others.

Due to the proliferation of music download sites, the adoption of new technology and promotional tie-ins with major brands, consumer music purchasing habits are rapidly changing. Scenarios for combining online sales with unique delivery systems and processes may spur the transition from CD sales to music downloads while providing streams of revenue for artists, distributors and other participants in the delivery process.

### SUMMARY OF THE INVENTION

In an aspect of the invention, a method of fund raising is provided. The method comprises the steps of providing a voucher for acquiring digital media content, sending a notification when the voucher is activated and providing a download of the digital media content when the voucher is redeemed.

In another aspect of the invention, a method for managing fundraising is provided. The method comprises the step of providing one or more vouchers each having a unique identifier for redemption of digital media content, the unique identifier also identifying the digital media content. The method further comprises the steps of receiving an activation notice including the unique identifier for at least one of the vouchers, checking that at least one voucher is activated using the unique identifier when the voucher is presented for redemption and authorizing a download of the digital media for redemption of the at least one voucher when the checking step determines that the voucher is activated.

In another aspect of the invention, a system for managing fund raising is provided. The system comprises at least one component to send a notification when the voucher is activated, to account for the voucher activation and to authorize a download of the digital media content when the voucher is redeemed.

In another aspect of the invention a system for managing fundraising is provided. The system comprises at least one component to provide one or more vouchers each having a unique identifier for redemption of digital media content, the unique identifier also identifying the digital media content, and to receive an activation notice including the unique identifier for at least one of the vouchers. The system further comprises at least one component to check that the at least one voucher is activated using the unique identifier when the voucher is presented for redemption and to authorize a download of the digital media for redemption of the at least one voucher when the checking step determines that the voucher is activated.

### BRIEF DESCRIPTION OF THE DRAWINGS

FIG. 1 is a block diagram of an embodiment of a system according to the invention;

FIG. 2 is a functional block diagram of an embodiment illustrating various interactions among various entities, according to the invention;

FIG. 3 is a functional block diagram of an illustrative embodiment of the invention;

FIG. 4 is a flow diagram of an embodiment showing steps of using the invention;

FIG. 5A is a flow diagram of an embodiment showing steps of creating media cards with partial IDs; and

FIG. 5B is a flow diagram of an embodiment showing steps of activating media cards.

### DETAILED DESCRIPTION OF EMBODIMENTS OF THE INVENTION

The invention relates to a system and method for fund-raising through online digital media content sales, particularly for non-profit organizations (NPOs) and other organizations (collectively, “organizations”). In embodiments of the invention, organizations may sell digital, downloadable music and other downloadable digital media content to organization members and external customers, and the organization may receive a royalty or commission on each sale (possibly in the form of a tax-free donation). Although the following descriptions and examples refers primarily to the sale of downloaded music, it should be understood that the system and method is also intended to encompass the sale and management of other types of products and downloadable digital entertainment media (e.g., music videos, live concerts, full-length feature films, short films, video games, interactive products, major sporting events, books, or the like).

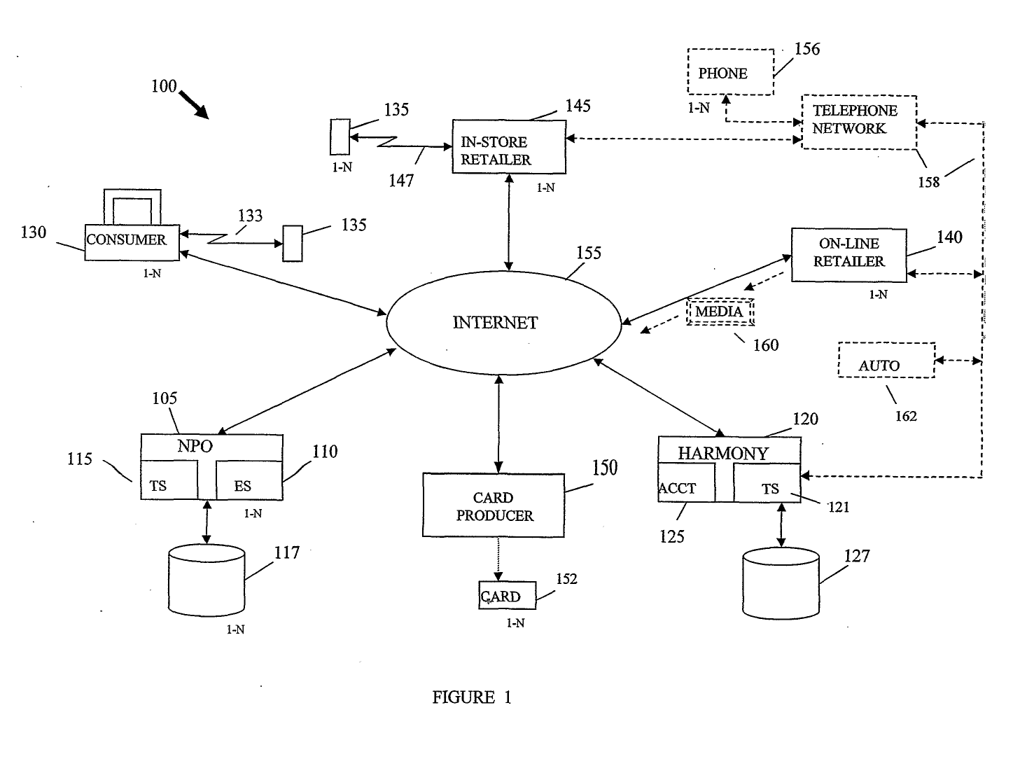

FIG. 1 is a block diagram of an embodiment of a system according to the invention, generally denoted as reference numeral 100. This system 100 comprises one or more organizations computing platforms 105 (e.g., personal computer (PC) and/or supporting servers) that may include educational software 110 for training organization's members, tracking software 115 for tracking sales and controlling allocations of product and a suitable database 117 for maintaining records.

The system 100 may also comprise a facilitator 120, generally known herein as Harmony, for controlling and managing certain operations of the system, as described below. Harmony 120 may be any suitable computing platform for executing coordination operations of the several components in the system and typically includes an accounting subsystem 125 for accounting for such activities as for example, sales, inventory, accounts payable, accounts receivable, security controls, memberships and account information for consumers and/or organizations. Harmony 120 may be a server or collection of distributed computing platforms and may interface with one or more databases 127 for maintaining system records. Harmony 120 may also include tracking software 121 for tracking the flow and status of the media cards and related activity throughout the media cards' lifetime. Harmony 120 may also provide the educational software 110 training platform to organizational users for educating the users on how to use the system of the invention.

Also included in the system 100 may be one or more consumer platforms 130 (e.g., a personal computer) that may access the other parts of the system 100 perhaps via a network, such as the Internet 155, for purchasing digital media 160. The consumers 130 may purchase (if required) and download the digital media 160 into portable players 135 such as an iPod® or similar player. In embodiments, the digital media 160 may be purchased from an on-line retailer 140 or an in-store retailer 145 in conjunction with oversight from Harmony 120. The one or more on-line retailers 140 are typically in communication with Harmony 120 for account information updates and typically employ a website, or an Internet Protocol enabled software application (such as, for example, Yahoo! Music's MusicMatch®, or Apple's iTunes®), for access by consumers to purchase music or other media.

The in-store retailers 145 may also have access to Harmony 120 via the Internet 145 for account updates and also typically have interfaces 147 to download media music or other media when purchased to portable players 135 such as iPods® or the like. The interfaces 147 may be wireless or wired communication ports suitable for downloading to the portable players 135. The in-store retailer 145 may maintain a repository of digital media available for sale and coordinates a sale with Harmony 120 for accounting reasons.

The system 100 may also comprise a card producer 150 which receives orders for media cards 152 (e.g., music cards) from Harmony 120 or organizations 105 that consumers may purchase from organization events or fund raising drives. The card producer 150 may be in communication with the organizations 110 and Harmony 120 as necessary to receive orders for producing and delivering cards for fund raising events.

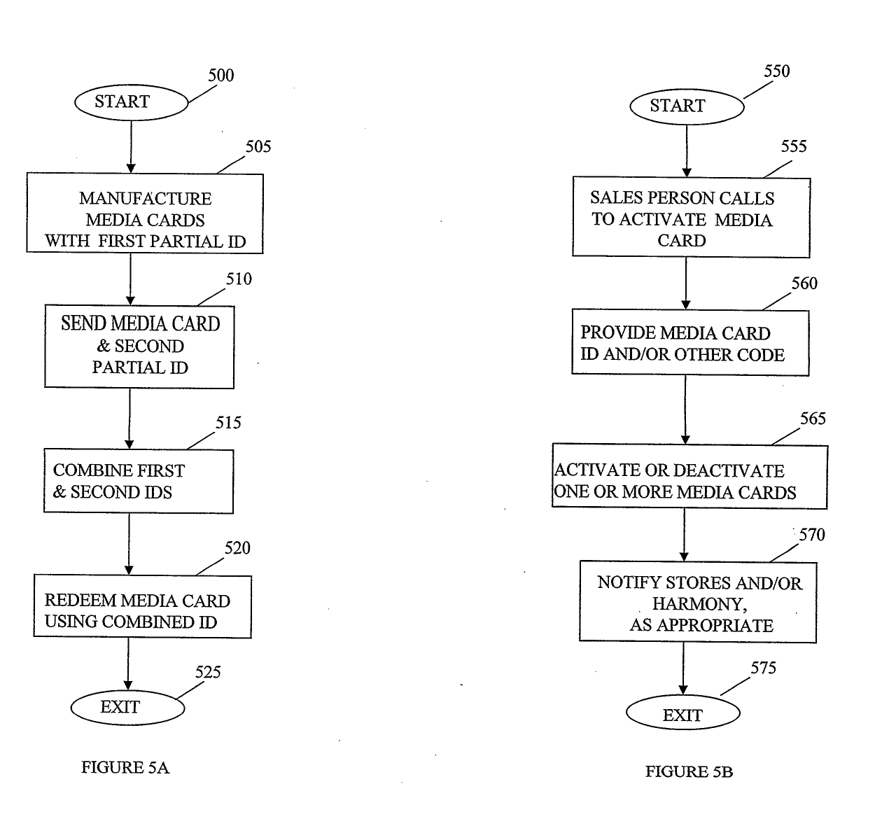

The system 100 may also include several optional components including one or more phones 156 for sales people to activate media cards 152 with an optional automatic activation system 162 interconnected by the optional telephone network 158. The automatic activation system 162 may forward activation notices via the optional telephone network 158 to the Harmony system 120, on-line retailers 140 or in-store retailers 145, as described in relation to FIG. 5B. In embodiments, the functions of the automatic activation system 162 may be a part of the Harmony system 120.

Harmony 120 is typically managed by a third-party for-profit corporation or similar entity to facilitate and manage relationships among the organizations, music labels and online music retailers. This includes, but is not limited to, negotiating financial arrangements, managing relationships, managing and tracking transactions and accounting, developing operational software and web-based portals, and coordinating the overall marketing effort among organizations and music providers. Harmony 120 may also work with the music industry to develop an educational program about the dangers of illegal downloading. The organizations may be required to present this educational program to their members in order to partake in the fund-raising methods. A small percent of the online revenue may also be directed to the Recording Industry Association of America (RIAA), or a similar organization, in order to ensure the support of the recording artist community.

Examples of participating organizations might include groups such as the National Parent Teachers Association (NPTA), Boys & Girls Club of America (BGCA), Girl Scouts of the USA (GSUSA), among a large number of other possible candidate organizations (including but not limited to: Parent Teachers Organizations (PTOs), BSA (Boy Scouts of America), YMCA, YWCA, PAL (Police Activities League/Police Athletic League), JA (Junior Achievement), National 4-H, Save the Children, Children's Defense Fund, UNICEF (United Nations Children's Fund), United Way, Youth Sports Leagues: i.e., Little League, Pop Warner, American Youth Service Organization (AYSO), Big Brothers/Big Sisters, Campfire Boys and Girls, Key Club International, High School Organizations, Youth Service America and its affiliates and the Make a Wish Foundation). These exemplary three organizations (PTA, BGCA, GSA) alone represent over 15 million members. However, any organization wishing to engage in fund-raising is a candidate for using the system and method of the invention and not just limited to these few referenced examples.

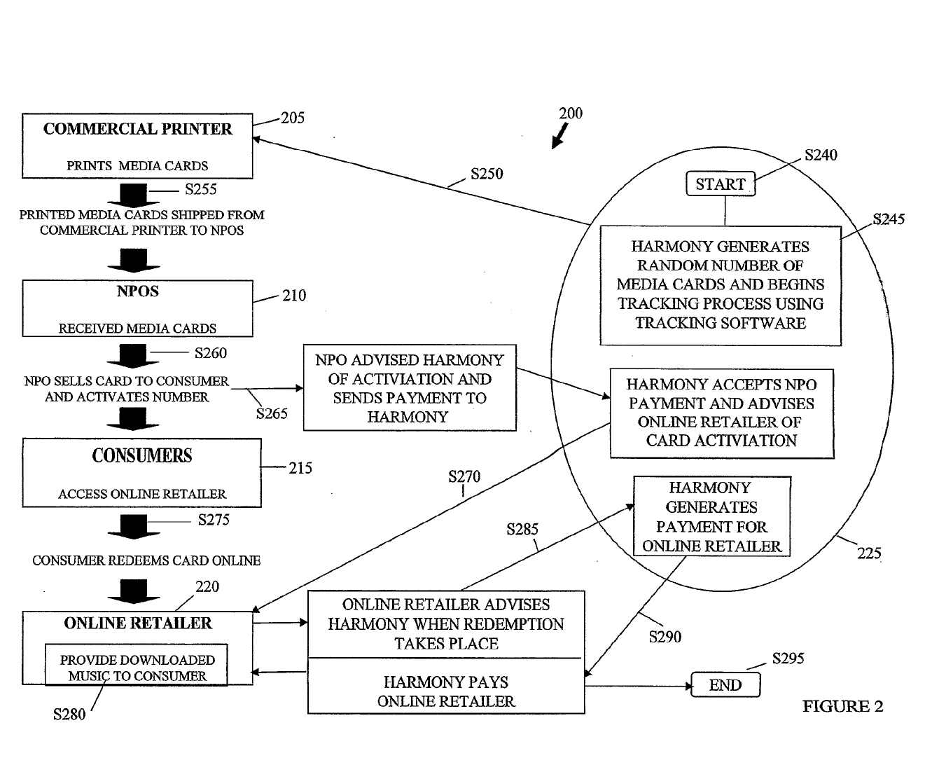

FIG. 2 is a functional block diagram of an embodiment illustrating various interactions among various entities according to the invention, generally denoted as reference numeral 200. FIG. 2 also shows steps of using the invention, beginning at step S240. The steps are designated as S240-S290. FIG. 2 (and all the other Figures or drawings showing steps) may equally represent a high-level block diagram of components of the invention implementing the steps thereof. The steps of FIG. 2 (and all the other Figures or drawings showing steps) may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network. The steps of FIG. 2 (and the other Figures showing steps) may also be implemented by the embodiment of FIG. 1.

The illustrative embodiment 200 may comprise a commercial printer 205 that produces media cards that may be sold by an organization to consumers for obtaining digital media, the organization 210 that receives the media cards for sale to one or more consumers 215. Also shown are an retailer 220 (which may, in embodiments, be either an on-line or in-store retailer) that provides access for obtaining digital media by the consumers 215 using the media card and a Harmony subsystem 225 that coordinates the inventory, tracking of sales, accounting, promotion and payments to the organizations 210 and suppliers of digital media.

Continuing now with the steps of FIG. 2, at step S245, the Harmony subsystem 225 may generate control numbers, perhaps randomly, for identifying the media cards (e.g., song cards). The numbers might also be a pre-generated and recorded list of numbers used to identify the media cards. At step S250, the numbers are provided to the commercial printer 205 for identifying each card produced.

At step S255, commercial media cards (e.g. card 152 of FIG. 1) which may be printed or encoded electronically, or both, are sent to the organizations 210. The organizations 210 may record the cards as part of their inventory. At step S260, the organization 210 sells the media cards to consumers. The card represents rights to a media download (e.g., a song, a movie, video, a book, or combinations thereof, etc). At step S265, the organization advises Harmony subsystem 225 of the card activation by providing the card identifier number and a payment (which might be a debit against an pre-established account). Alternatively, if the media cards were prepaid by the organization than a payment may not be required.

At step S270, Harmony subsystem 225 accepts the organization's 210 payment and advises a retailer 220 (e.g., an on-line retailer) of the card's activation and supplies the card identifier. Alternatively, in embodiments, the Harmony subsystem 225 may bundle multiple activations with multiple card numbers into a single notification to the retailer 220.

At step S280, the retailer 220 provides a media content file, e.g., music, interactive file, a game file, video, books, and the like, or combinations (e.g., a movie with accompanying song track) as appropriate to a consumer when the consumer 215 redeems the card. This may occur by on-line redemption and download, or by in-store redemption with an in-store download. At step S285, the retailer subsystem advises the Harmony subsystem 225 that one or more cards has been redeemed and supplies the appropriate card identifiers. At step S290, the Harmony subsystem 225 records the redemption of the media card, optionally inhibits future purchases using the card, and issues payment to the retailer 220. Payments may be cumulative over a time period, in accordance with any pre-established terms. At step S295, the process ends.

Alternatively, other techniques for activating cards may be employed. One technique for activation requires no online interaction on the part of the organizations, which may be advantageous. Rather, at such time that cards are manufactured, they are done so with only half of an identifier (or number/code). The second half of the card identifier is also created in the form of a sticker, for example. Thus, both the card, and the sticker have partial identifiers. The card is then sent to the organization, and then, separately, the sticker is sent to the organization. During a sale of the card, the sticker may be applied to the card by the organization salesperson. In combination, the two identifiers activate the card, by forming a complete authorized identifier. At such time that the customer enters the complete two-part identifier at the online music store, the card may be redeemed. This process of sending two parts of the identifier separately may overcome the possibility that stolen cards may be redeemed by thieves.

Another technique for activating cards also requires no online interaction on the part of the organizations. In this case, a phone (e.g., landline, voice over Internet protocol, or cellular) is used to contact an automated system which allows the sales person to securely login, enter the card number, or a card code, and choose to activate, or deactivate at least one card. The instruction may then be electronically forwarded to the centralized system (i.e., Harmony) and music store, as appropriate. This activation scenario may have the benefit of being able to be performed whenever, and wherever cards are sold (in the case of a cellular phone), and additionally overcomes the problem of providing the capability of immediate electronic activation of cards by any salespeople who do not have access to a computer.

The system and method may also provide unique and practical incentives on many levels such as providing suitable ease of use and attractive results for meeting performance goals of organization's fundraising endeavors. For example, these incentives may include but not limited to the following:
Low-cost/easy-to-implement: Mass production and distribution costs of digital music are minimal (unlike physical items or one-off fund-raising events), and there is no up-front production costs or physical inventory to maintain.
Incremental income: With extensive ties to the community, the partner organizations are typically able to provide local and national outreach to consumers such as evangelizing the inevitable distribution and format shift from CDs to digital music downloads. The organizations may also give the music labels a significant spike in digital music sales while also enabling the facilitator to structure partnerships with music labels in order to direct a significant and ongoing percentage of the music revenue to partner organizations and other organizations. The net result might result in millions of dollars in revenue on an ongoing basis for the organizations.
Broad appeal: Music appeals to people of all ages, religions and cultural groups. Increasingly, people of all ages now own, operate and are comfortable with computers and the Internet. One concern that many people still have is the use of credit cards on the Internet, and this concern might be eliminated in embodiments of the invention by allowing for face-to-face purchases from trusted members of the fund-raising organization, or other similar organization. In other embodiments of the invention, parents may be motivated to buy music online with their children using the parent's credit card, allowing parents to guide their children's music purchases. Regardless of the embodiment, the invention supports the message that file sharing is illegal and punishable by law.
Public service: For years, the music labels have been struggling to educate and dissuade the public from illegally downloading and sharing digital music. Unfortunately, the music industry's prevention program has largely been conducted through somewhat negative methods, e.g., warnings, legal action and associated press releases. Instead of intimidating and ostracizing consumers, the invention becomes part of the overall solution, reinforcing the value of digital music, and enabling organizations to benefit directly from each sale. An educational program aimed at all of the organization's members and customers to emphasize the dangers of illegal downloading may be viewed very positively by the organizations, the Artists and the Music Labels. Accordingly, educational modules or components may be provided in methods according to the invention.
Clean Content: Whereas parents who let their children download music from the Internet without the invention run the risk of having their children encounter content, like songs, that have explicit lyrics or content. However, embodiments of this invention may provide the music store to serve a “clean version” (e.g., filtered of explicit material) of the store to all users of song cards, since the distribution is more tightly controlled. This will give parents a safe way to let their kids download content online.

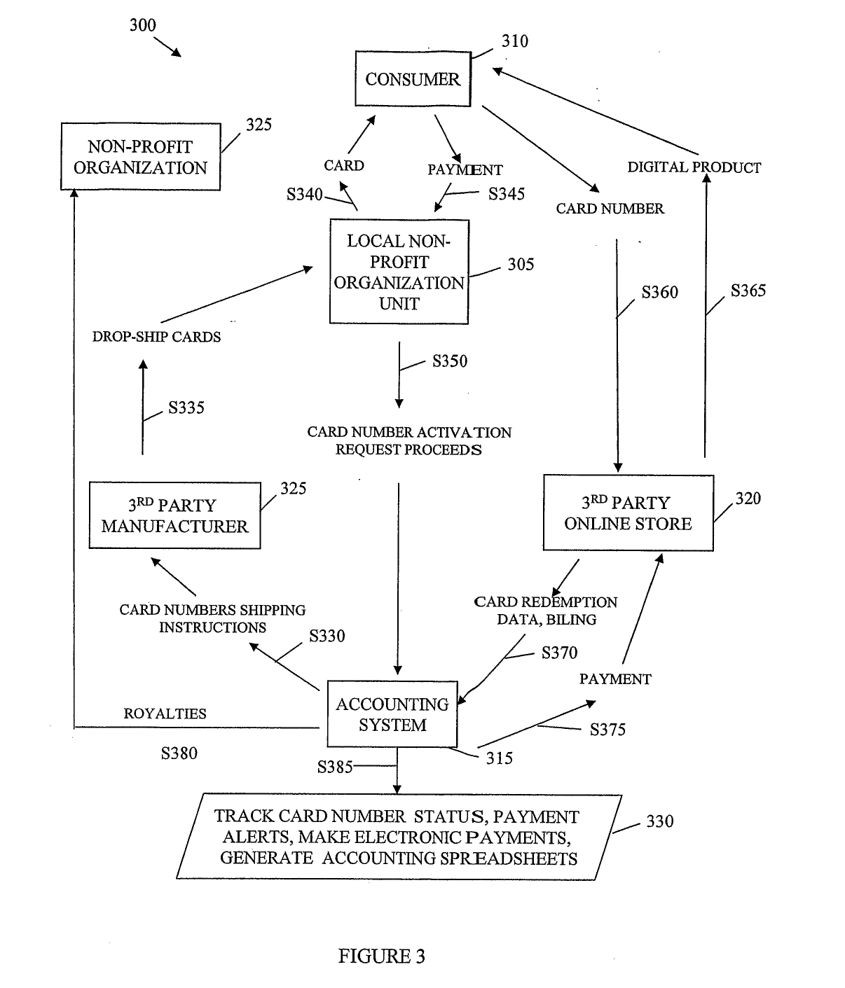

FIG. 3 is a functional block diagram of an illustrative embodiment of the invention, generally designated as reference numeral 300. FIG. 3 also shows steps of using the invention; the steps overall are designated as S330-S380. The process begins at step S330 where an accounting system 315 associated with Harmony provides one or more orders for media cards to a third party card manufacturer 325. The one or more orders may include card identifiers (e.g., random numbers or ranges of numbers) for marking the media cards. The marking might be printed or encoded electronically onto the cards (e.g., bar coded, radio frequency ID (RFID), magnetic strip, or the like). At step S335, the third party manufacturer ships the cards according to an order to an organization 305, perhaps a non-profit organization having local units under the umbrella of a national organization. At step S340, the organization 305 might promote the media card as part of a fund raiser or benefit drive and sell one or more media cards to a consumer 310. At step S345, the consumer pays for the media card.

At step S350, the organization 305 provides notification to the accounting system 315 of any cards sold for activating the card so that the consumer is capable of converting the media card into actual media. Any sales proceeds may also be conveyed to the accounting system at this time, if appropriate according to terms and conditions previously established.

At step S360, the consumer 310 presents the card and/or card number to a third party distributor 320, such as an on-line store via a website, for redeeming the card for actual media. At step S365, the digital product(s) may be downloaded to the customer's portable player, computer, television, or similar device for the customer's use. At S370, the third party distributor 320 provides card redemption data including card numbers to the accounting system 315. The accounting system records the redemption and typically removes the card number from future use. At step S375, a payment or credit may be made to the third party distributor 320.

At step S380, any royalties may be made to the organization, perhaps the national headquarters 325. Also, any royalties to the media producers (e.g., music labels, artists) might be paid, if appropriate. At step S385, various reports are periodically produced summarizing card usage, inventory of cards, card number series available or used, payment alerts and spreadsheets showing financial operations, or the like. Also, any electronic payments may also be initiated for running the system or to participants.

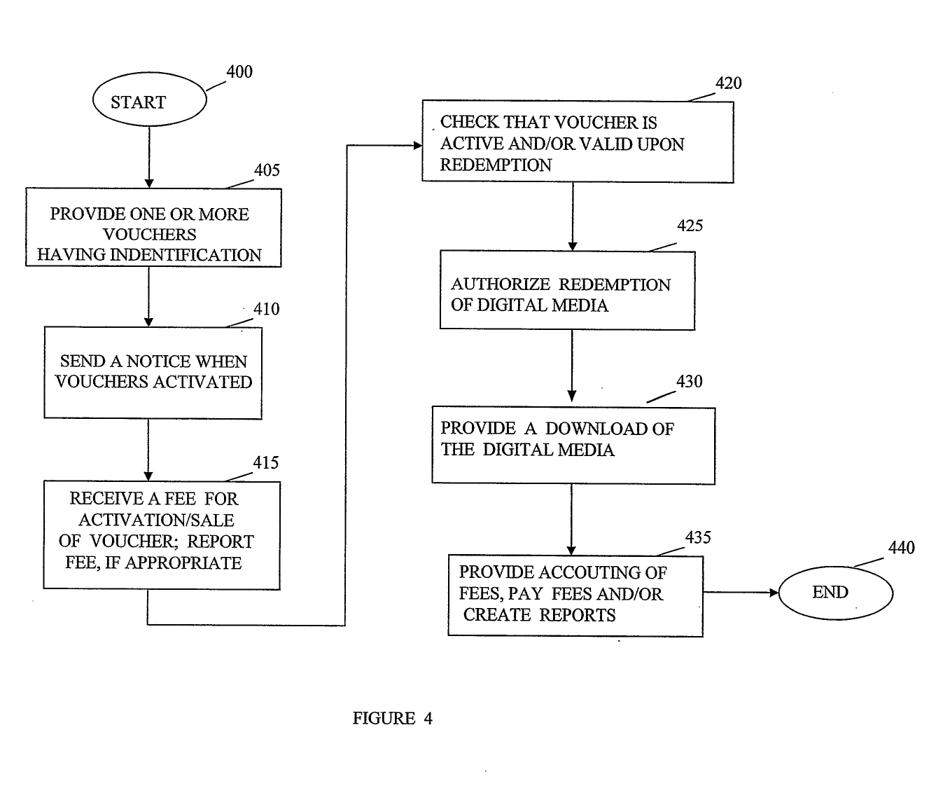

FIG. 4 is a flow diagram of an embodiment showing steps of using the invention, starting at step 400. At step 405, one or more vouchers (e.g., song cards, media cards, or the like) with identifiers such as numbers, bar code, electronic encoded identification (e.g., magnetic strips, chips, RFID), or similar electronic or non-electronic identification may be produced, perhaps by a third party manufacturer, and distributed to organizations that wish to sell or promote (e.g., for fund raising) the media content associated with the vouchers. The numbers may be randomly generated and allocated based on participating organizations. An identifier (which may be the voucher id) may also be included denoting the specific media content(s) associated with the voucher. The identifier may also comprise a plurality of partial codes assembled by a user of the vouchers (e.g., organizations) to prevent theft or unauthorized use. The partial codes may be sent independently to the user.

At step 410, an organization may send an activation notice to a centralized system to indicate that the vouchers have been activated and ready for promotion, and perhaps even already sold. The activation notice may also provide the identifiers of the vouchers and may also contain specific identification (perhaps encoded) of associated media content. The centralized system may maintain accounting of the status of the vouchers (e.g. activated or not; redeemed or not) for the organization and perhaps other organizations promoting similar types vouchers. The accounting is typically set up and defined when a fund raising agreement, for example, has been reached between the accounting/control system (e.g., Harmony) and an organization.

At step 415, when an organization sells one or more vouchers, a report may be provided to the accounting system (i.e., Harmony), usually along with any collected sales fee. An activation fee may also be optionally included, if appropriate according to a predetermined agreement. At step 420, when a consumer attempts to redeem the one or more vouchers, either through an on-line media provider (e.g., a web-site) or an in-store redemption location, a check is made whether the one or more vouchers has been activated and is currently valid for redemption. This may be accomplished by using the voucher identifier and cross-checking in a redemption database that is maintained by either the centralized accounting system (e.g., Harmony) or by the on-line media or in-store media provider. Alternatively, when a consumer presents a voucher for redemption, a real-time request may be made to the centralized accounting system to check whether the voucher is active and valid.

At step 425, an authorization may be provided to permit redemption of the one or more vouchers. This may accomplished by a confirmation message from the centralized accounting system or accomplished when the on-line provider (or in-store location) successfully checks an updated database for status of the one or more vouchers.

At step 430, when the one or more vouchers are deemed valid and current, a download of digital media to the consumer's digital media player, computer, television, or similar device may proceed. The particular digital media downloaded may be tied to the voucher identifier or similar encoded information associated with the voucher. Multiple types (e.g., music, text, video, animation, games, or the like) of media content may be provided, as appropriate. Filtering of explicit material may also be performed.

At step 435, an accounting of the sales, activation of the vouchers, redemption of the vouchers, inventory of vouchers, recordation of fees, payment of fees, and/or report generation for any of these activities may be made to participating entities (e.g., organizations, media providers, artists, manufacturers, or the like). At step 440, the process ends.

FIG. 5A is a flow diagram of an embodiment showing steps of creating media cards with partial IDs, starting at step 500. At step 505, one or more media cards (or vouchers) may be produced with a partial ID encoded in or printed on the media cards. The partial ID may prevent unauthorized use of the media card if lost or stolen. At step 510, the one or more media cards with partial IDs may be distributed to an organization for use while other partial identifiers are distributed separately to the organization. At step 515, the partial IDs may be combined and applied to the one or media cards producing a unique identifier for each media card. The combined partial IDs that produce the unique identifiers may be completed by application of stickers, for example, or encoded electronically, as appropriate. At step 520, one or more media cards may be redeemed for actual media using the unique identifier created by combining one or more partial identifiers. At step 525, the process ends.

FIG. 5B is a flow diagram of an embodiment showing steps of activating media cards, starting at step 550. At step 555, a sales person of an organization, or similar individual, may activate a media card (or voucher) by calling an automated system by establishing a telephone call. At step 560, the sales person may be asked to authenticate themselves and prompted to provide one or more media card identifiers or media card ID ranges for activation. This may be done at the time of sale of the media card, for example, perhaps at a location remote from computer accessible equipment. At step 565, the one or more media cards may be activated (or deactivated) once the one or more media cards IDs have been received. At step 570, the activation or deactivation notice may be distributed to participating on-line stores, in-store locations, or the Harmony system for tracking, authorization of downloads, or deactivation of the one or more media cards, as appropriate. At step 575 the process ends.

### EXAMPLES OF USING THE INVENTION

The following examples illustrate different levels of facilitator (e.g. Harmony) involvement that might be possible according to the invention. Except for the first example, all examples include partnerships with at least one Retail Partner (e.g., iTunes®, Yahoo! Music®, Napster®, Wal-Mart®, etc). Depending on the preference of the individual NPOs, any or all of these approaches could be implemented.

Music Store Hosting:

In this scenario, an Original Online Music Store would be hosted and maintained at the NPO's website. This typically would be independent from any other online retailer of digital music.

Private-Branded Download Application:

With this approach, a retailer, such as Apple Computer, might create a branded version of an existing software application for digital media content sales (e.g., Yahoo! MusicMatch, or, in the case of Apple Computer, the iTunes® software application) functionally identical to the regular software version, but branded with the organization's name. The branded software application may be offered as an option to new users and perhaps as an upgrade for existing users of the software. The NPO or organization may distribute the application on CD to members.

Private-Branded, Clean, Download Application:

With this approach, a retailer, might create a branded version of an existing software application for digital media content sales (e.g., Yahoo! MusicMatch, or, in the case of Apple Computer, the iTunes® software application) functionally identical to the regular software version, but branded or co-branded with the organization's name, and where access is restricted to clean songs (any song not labeled “explicit”) only. The branded software application may be offered as an option to new users and perhaps as an upgrade for existing users of the software. The NPO or organization may distribute the application on CD to members.

Music Store Facade:

Using the facade approach, a digital content store may be constructed such that it appears to the user that the service is being hosted at the organization's website. In actuality, the content/transactions might be served to the organization's website within a frame, or window, but hosted offsite by a retail partner.

Music Store Portal:

The user may simply click-through to a retail partner's store from the NPO's website.

Using this configuration, it is possible for the organization's website to have links to several partners' sites.

NPO Music Store within Retail Partner:

The Retail Partner might host a sub-store at its site, but branded with the NPO's name.

NPO Donation Option:

The Retail Partner might include an NPO donation button on transaction page.

NPO Codes:

The NPO's code numbers might be entered into the Retail Partner's “gift certificate” data entry field.

As was noted above, the implementation topology and details of operations may differ from one NPO to another. In general, the facilitator negotiates the deals, manages the relationships, manages and tracks the transactions/accounting, and works with the non-profit partners to create the best marketing and communications strategy in conjunction with the partners, the labels, artists and online retailers. These roles are described below in more detail.

In another example of a using the invention, the actual sales transaction is handled offline, i.e., in person or through a more traditional “brick and mortar” store. The facilitator creates, for example, paper vouchers containing codes that, when entered into an appropriate information system, are redeemable for digital media content. Before the vouchers are distributed, the facilitator may store the code numbers in a database, optionally along with information on where vouchers containing individual codes are distributed, so that once a sale is made, a determination may be made as to which organization or individual within that organization was responsible for the sale. It should be understood that although paper vouchers may be convenient for some implementations of these methods, the codes may be distributed in any way, including network or internet-based distribution though an electronic system that enables the organization to print vouchers on demand. In other embodiments, codes or vouchers may be distributed electronically via e-mail, website, wireless, physical, or other conventional distribution means.

Once the code has been purchased, the consumer directs a web browser to a designated site, selects the digital media content in which he or she is interested, and enters the code in lieu of credit card or another form of payment. Alternatively, the user may access a network-connected dedicated software application, as is the case, for example, with Apple's iTunes® software. The payment may be processed, the sales information sent to the facilitator, and the user permitted to download the digital content.

Offline handling of the sales transaction allows the consumer to avoid transmitting credit card information online. Offline handling of the sales transaction also allows for more flexible selling options, including person-to-person sales by representatives of the organization and sales of digital media content alongside traditional fundraising products, such as cookies.

The designated website may be implemented in any number of ways. For example, the designated website may be directly implemented as part of the NPO or other organization's website. Alternatively, the designated website may be web content that is provided and maintained by a third party server and may be configured and branded to appear to be a part of the organization's website. If the organization does not wish for music sales to be conducted through their website, or to appear to be conducted through their website, the designated website may be a conventional retailer's website, which may be accessed through a link on the organization's website.

If an organization is linked to a retailer's website, when the user activates the link to go to the retailer's website, the organization's web server provides information to the retailer's web servers (e.g., by constructing a specific uniform resource locator) that indicates the identity of the referring organization and any other information necessary or desirable for sales tracking.

If the organization does not wish to host a digital content sales website, appear to host such a website, or act as a linked referrer to a retailer that does host such a website, methods according to the invention may be implemented in which a retailer's website may be modified so that a user can shop directly to the retailer's website and enter an appropriate code (alternatively, checking an appropriate box on a form, entering a zip code, or via a pull down menu) so that the organization receives credit for the purchase.

As was noted above, a network-connected software application may be used instead of a website. In this case, the application may be configured and content delivered in much the same way as the website content. For example, the application may access content stored on the organization's electronic systems, content stored on the facilitator's electronic systems, or content stored directly on a retailer's electronic systems. The software application may also be branded as desired, for example, with the organization's name and logo, with the facilitator's name and logo, or with the organization's name and logo in combination with other branding.

Financial transaction processing may also be implemented in several variations. For example, during financial transaction processing with codes and vouchers, the designated website may be configured to transmit the code information to the facilitator, either instantaneously or on a regular basis, and the facilitator would then reimburse the retailer an appropriate amount, either immediately or on a regular basis. Alternatively, the retailer may transmit a donation or royalty directly to the organization and provide the facilitator with only the code and sales tracking information.

In other embodiments, the consumer may use credit cards, debit cards, automatic clearing house (ACH) transactions, or any other form of payment that may be accepted electronically, to purchase digital media content. In embodiments using any of those forms of payment, the designated website or software application may be configured in any of the ways described above. The use of more direct electronic payment may provide additional flexibility, particularly for the retailer. For example, instead of being reimbursed by the facilitator, the retailer may configure a website or software application such that some designated percentage of each sale is directed to the facilitator, either immediately as a part of the electronic transaction or on a regular basis. The facilitator may then forward a designated portion of receipts to the organization. Alternatively, as was described above, a designated portion of the receipts may be forwarded directly to the organization, with sales and tracking information being provided to the facilitator.

In addition to involvement in sales, and as was described above, the facilitator may provide the organization with a software application that includes sales tracking and educational modules. The sales tracking module may provide the organization with a record of total receipts, and if codes or other local organization sales unit (for example, a Girl Scout Troop) or individual tracking measures are employed, with a breakdown of sales by a local organization sales unit, or an individual organization member. In addition to providing sales figures, the sales module may be configured to allow for contests between local organization sales units or individual organization members based on the sales total for each local unit or member. For example, one possible prize in such a contest may be a live performance by one or more musical artists for the winner of the contest.

The educational module may be configured to provide hands-on instruction to organization members as to how the fund-raising system is to be used, and may also provide on-demand printing of instructional or marketing materials for distribution to customers.

Both the educational and the sales tracking modules may be provided as stand-alone software applications, as portions of an organization's web-based intranet, or as websites or portions thereof. Regardless of the type of implementation, each member of the organization may have a personal ID number or log-in to enable personalized, trackable access to the educational and sales tracking modules.

The educational module may communicate with the organization's information systems or with those of the facilitator so that it can be confirmed that each member of the organization has undergone any training which might be made mandatory, including training on the software and sales techniques, as well as training on the legal implications of digital media content sharing.

Typically, depending on the particular arrangement within the organization, the facilitator may take some portion of the proceeds and may provide the remainder to the organization. Additionally, as was described above, the facilitator may donate some portion of the proceeds to a media industry charity or pay a royalty according to pre-agreed terms. The facilitator may also arrange for branded hardware products, such as MP3 players, to complement the fund-raising campaign for each organization.

Negotiation of financial arrangements, management of relationships between organizations, retailers, and digital media content developers and coordination of the overall effort may be conducted in a traditional offline manner, depending on the needs of the parties. However, the facilitator may, for example, negotiate certain arrangements with a number of retailers and content providers without regard to any particular organization.

If the facilitator makes arrangements with content providers without regard to particular organizations, the facilitator may provide a website or other network-enabled software application that allows organizations to automatically sign up for fund-raising digital media content sales through the facilitator. The software application may first check eligibility for the program by recording responses to a number of eligibility questions and comparing the responses to an acceptable response set. Once eligibility is determined, the application may provide for the selection of the appropriate content and terms under which that content is to be sold, identification of and set-up for the organization's selling members, identification and set-up of the sales tracking modules and any desired contests or sales incentives, and identification and set-up of the desired educational programs.

The following provides some measure of definition for various music related terms.

Digital Music download:

Music sold on the Internet for use on hand-held personal players, iPods®, computers, home stereo systems, personal digital assistants (PDAs), flash memory devices, automobiles, boom-boxes, music-playing enabled cell phones, etc. Digital music downloads may also be burned to compact disks (CDs). Downloads may also be accomplished in an “in-store” transfer arrangement from a computer to a player. Downloads may also be accomplished wirelessly over cellular networks, or other wireless networks (including 802.11 g, Bluetooth, etc.)

Online Music Retailer:

An online, web-based retail outlet offering download digital music for sale to consumers. Examples of this are iTunes®, Yahoo!Music, Wal-Mart, Napster® and “Buymusic.com”. Typically, these retailers offer hundreds of thousands of songs available for instant download for prices ranging, for example, from $0.88 to $0.99 per song and $9.99 per album.

Music Labels:

Businesses such as Sony, BMG, Universal, Warner Music, EMI and many others that have artists under contract, produce music, and serve as the link between artists and consumers.

Traditional Retail Outlets:

Brick and mortar retail stores offering hard format music for sale to consumers. These can be specialty music stores or mass merchandisers.

Artists:

The actual performers or authors of the music.

RIAA:

Recording Industry Association of America. A trade association of Music Labels artists whose primary purpose is to protect the financial and legal interests of the music industry.

While the invention has been described in terms of embodiments, those skilled in the art will recognize that the invention can be practiced with modifications and in the spirit and scope of the appended claims.

What is claimed is:

1. A method of fund raising, comprising the steps of:
providing a voucher for acquiring digital media content;
sending a notification when the voucher is activated; and
providing a download of the digital media content when the voucher is redeemed.

2. The method of claim 1, wherein the providing voucher step includes charging a fee for the voucher.

3. The method of claim 1, wherein the providing a voucher step includes providing a voucher with a voucher identifier.

4. The method of claim 3, wherein the voucher identifier comprises at least any one of a printed number, an encoded identifier and identification of the digital media content.

5. The method of claim 3, further comprising creating the voucher identifier by combining at least two partial identifier codes.

6. The method of claim 1, further comprising the steps of:
activating the voucher after receiving payment for the voucher; and
reporting the activation including an identifier of the voucher and the payment to a centralized accounting system.

7. The method of claim 1, wherein the providing a download comprises the steps of:
receiving an identifier of the voucher at an on-line retailer;
validating that the voucher is activated based on the identifier; and
downloading the digital media content to a media player when the voucher is activated.

8. The method of claim 7, further comprising filtering the digital media to exclude explicit media.

9. The method of claim 1, further comprising the steps of:
activating the voucher by establishing a phone call to an automated activation unit; and
providing an ID associated with the voucher.

10. The method of claim 9, further comprising the step of distributing a notice that the voucher has been activated.

11. A method for managing fundraising, comprising the steps of:
providing one or more vouchers each having a unique identifier for redemption of digital media content;
receiving an activation notice including the unique identifier for at least one of the vouchers;
checking that the at least one voucher is activated using the unique identifier when the voucher is presented for redemption; and
authorizing a download of the digital media for redemption of the at least one voucher when the checking step determines that the voucher is activated.

12. The method of claim 11, further comprising the steps of:
receiving a payment for the activation and accounting for the payment on behalf of an entity associated with the voucher; and
paying another entity when the download has occurred.

13. The method of claim 11, further comprising the step of tracking the one or more vouchers using the identifiers so that the voucher is deactivated when redeemed preventing another redemption by the at least one voucher.

14. The method of claim 11, wherein the providing step provides the one or more vouchers to one or more entities for fund raising and accounts for the provided one or more vouchers by entity and further comprises the steps of:
receiving a payment for sale of the provided one or more vouchers and accounting for the payment of the provided one or more vouchers on behalf of the one or more entities; and
reimbursing the one or more entities for at least a portion of the payment according to the provided one or more vouchers to each of the one or more entities.

15. The method of claim 11, further comprising at least any one of the following steps:
providing a report on voucher identifiers including activation status;
providing a report on sales of the digital media content;
providing an accounting spreadsheet;
providing a report on sales for one or more digital media providers; and
providing a report of account balances for one or more entities selling the one or more vouchers.

16. The method of claim 11, wherein the download of digital media content comprises downloading digital media content associated with the unique voucher identifier, the digital media content being at least any one of a video file, a music file, an animation file, a game file, an interactive file, a text file, a speech file.

17. A system for managing fund raising, comprising at least one component to:
send a notification when a voucher is activated;
account for the voucher activation; and
authorize a download of the digital media content when the voucher is redeemed.

18. The system of claim 17, wherein the at least one component to account for the voucher activation accounts for a fee received for the voucher.

19. The system of claim 17, wherein the at least one component to send the notification sends an identifier associated with the voucher.

20. The system of claim 19, wherein the identifier is at least any one of a printed number, an encoded identifier and an identification of the digital media content.

21. The system of claim 19, wherein the identifier comprises a plurality of partial codes.

22. The system of claim 17, further comprising the at least one component to:
activate the voucher after receiving payment for the voucher; and
report the activation including an identifier of the voucher and the payment to a centralized accounting system.

23. The system of claim 17, further comprising the at least one component to:
receive an identifier of the voucher at an on-line retailer;
validate that the voucher is activated based on the identifier; and
download the digital media content to a media player when the voucher is activated.

24. The system of claim 17, further comprising the at least one component to receive a telephone call for activating the voucher.

25. A system for managing fundraising, comprising at least one component to:
provide one or more vouchers each having a unique identifier for redemption of digital media content;
receive an activation notice including the unique identifier for at least one of the vouchers;
check that the at least one of the vouchers is activated using the unique identifier when the at least one of the vouchers is presented for redemption; and
authorize a download of the digital media for redemption of the at least one of the vouchers when the checking step determines that the at least one of the vouchers is activated.

26. The system of claim 25, further comprising the at least one component to:
receive a payment for the activation and accounting for the payment on behalf of an entity associated with the at least one of the vouchers; and
pay another entity when the download has occurred.

27. The system of claim 25, further comprising the at least one component to track the one or more vouchers using the unique identifier so that the at least one of the vouchers is deactivated when redeemed to prevent another redemption by the at least one of the vouchers.

28. The system of claim 25, wherein the at least one component provides the one or more vouchers to one or more entities for fund raising and accounts for the provided one or more vouchers according to each of the one or more entities, and further comprising the at least one component to:
receive a payment for sale of the provided one or more vouchers and to account for the payment of the provided one or more vouchers on behalf of the one or more entities; and
reimburse the one or more entities for at least a portion of the payment according to the provided one or more vouchers to each of the one or more entities.

29. The system of claim 25, further comprising at least any one of:
the at least one component to provide a report on any voucher identifier including activation status;
the at least one component to provide a report on sales of the digital media content;
the at least one component to provide an accounting spreadsheet;
the at least one component to provide a report on sales for one or more digital media providers; and
the at least one component to provide a report of account balances for one or more entities selling the one or more vouchers.

30. The system of claim 25, wherein the download of digital media content comprises the at least one component to download digital media content associated with the unique voucher identifier, the digital media content being at least any one of a video file, a music file, an animation file, a game file, an interactive file, a text file, a speech file.

31. The system of claim 25, further comprising the at least one component to:
track the status of the one or more vouchers based on the unique identifier throughout the functional lifetime of the one or more vouchers; and
provide educational training to organization members.

32. The system of claim 25, wherein the activation notice is achieved by one of an on-line activation and a telephone call activation.
